(19) United States
(12) Patent Application Publication
(10) Pub. No.: US 2019/0281771 A1
(43) Pub. Date: Sep. 19, 2019

(54) APPARATUS, SYSTEM, AND METHOD FOR INDOOR GROWTH

(71) Applicant: Michael Setton, London (GB)

(72) Inventor: Michael Setton, London (GB)

(21) Appl. No.: 16/356,664

(22) Filed: Mar. 18, 2019

Related U.S. Application Data
(60) Provisional application No. 62/644,500, filed on Mar. 18, 2018.

(51) Int. Cl. A01G 9/26; A01G 9/24; A01G 24/22; B65G 1/04; B65G 1/10

(52) U.S. Cl. CPC A01G 9/26; A01G 9/249; B65G 1/10; B65G 1/0478; A01G 24/22

(57) ABSTRACT

A method is disclosed. The method includes providing a first movable assembly that is movable between a first location and a second location of a structure, providing a second movable assembly that is movable between a third location and a fourth location of the structure, and disposing a first growth material in the first movable assembly and a second growth material in the second movable assembly. The method also includes illuminating the first growth material from a first position at the first location at a first time and from a second position at the second location at a second time, and illuminating the second growth material from a third position at the third location at the first time and from a fourth position at the fourth location at the second time.

### CROSS-REFERENCE TO RELATED APPLICATIONS

This application claims the benefit of the following provisional application, which is hereby incorporated by reference in its entirety: provisional application No. 62/644,500 filed Mar. 18, 2018.

### TECHNICAL FIELD

The present disclosure generally relates to an apparatus, system, and method for growth, and more particularly to an apparatus, system, and method for indoor growing.

### BACKGROUND

Vertical farming techniques have emerged in recent years as an alternative to traditional field-based agricultural methods. The major cost factors associated with vertical farming involve labor and electricity. Electricity consumption in indoor agriculture is primarily related to lighting necessary to promote photosynthesis and drive metabolic pathways.

In vertical farming, lighting is typically placed at a fixed distance that is usually kept at a minimum because light intensity is inversely proportional to the square of the distance between a light source and a growing organism. Because they generate significantly less heat than other sources of photons, light-emitting diodes (LEDs) may be placed significantly closer to plants as compared to other light sources such as incandescent light bulbs. LEDs having a fixed ratio of red and blue wavelengths or a full spectrum of wavelengths are typically used in vertical farming. However, existing vertical farming methods, either with or without LEDs, involve non-uniform illumination of plant canopies and poor intra-canopy light penetration.

Also, many conventional vertical farming techniques mimic the solar full spectrum. Adjustments based on such techniques may have an impact on growth rate of plants by enhancing photosynthesis, but may not allow for an altering of plant traits by activating or suppressing specific phytochromic activity.

The exemplary disclosed apparatus, system, and method are directed to overcoming one or more of the shortcomings set forth above and/or other deficiencies in existing technology.

### SUMMARY OF THE DISCLOSURE

In one exemplary aspect, the present disclosure is directed to a method. The method includes providing a first movable assembly that is movable between a first location and a second location of a structure, providing a second movable assembly that is movable between a third location and a fourth location of the structure, and disposing a first growth material in the first movable assembly and a second growth material in the second movable assembly. The method also includes illuminating the first growth material from a first position at the first location at a first time and from a second position at the second location at a second time, and illuminating the second growth material from a third position at the third location at the first time and from a fourth position at the fourth location at the second time. A first distance between the first location and the third location is less than a second distance between the second location and the fourth location. The second position is an intra-canopy position of the first growth material. The fourth position is an intra-canopy position of the second growth material.

In another aspect, the present disclosure is directed to a system. The system includes a growth module, comprising computer-executable code stored in non-volatile memory, a processor, a sensor array, a lighting array, and a dispensing array. The growth module, the processor, the sensor array, the lighting array, and the dispensing array are configured to sense data of a growth material using the sensor array, process the sensed data, illuminate the growth material using the lighting array, dispense a fluid to the growth material using the dispensing array, vary a position of at least one lighting assembly of the lighting array between a first position and a second position based on the sensed data, vary an illumination intensity and an illumination duration of the lighting array based on the sensed data, and vary an amount of the dispensed fluid based on the sensed data. The first position is disposed above a canopy of the growth material and the second position is disposed below the canopy of the growth material.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention;

FIG. 4 is a schematic view of an exemplary embodiment of the present invention;

FIG. 5 is a schematic view of an exemplary embodiment of the present invention;

FIG. 6 is a schematic view of an exemplary embodiment of the present invention;

FIG. 7 is a schematic view of an exemplary embodiment of the present invention;

FIG. 8A is a schematic view of an exemplary embodiment of the present invention;

FIG. 8B is a schematic view of an exemplary embodiment of the present invention;

FIG. 9 illustrates an exemplary process of an exemplary embodiment of the present invention;

FIG. 10 is a schematic illustration of an exemplary computing device, in accordance with at least some exemplary embodiments of the present disclosure; and

FIG. 11 is a schematic illustration of an exemplary network, in accordance with at least some exemplary embodiments of the present disclosure.

### DETAILED DESCRIPTION AND INDUSTRIAL APPLICABILITY

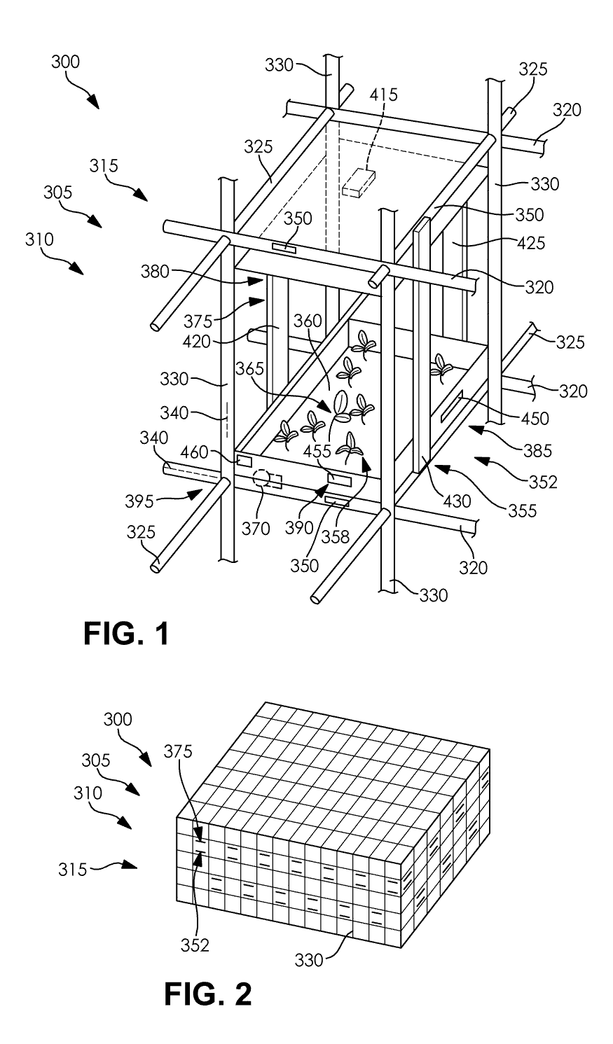

FIG. 1 illustrates an exemplary system 300 for indoor growing. For example, system 300 may be an indoor environment growth system such as a vertical farming system. In at least some exemplary embodiments, system 300 may be a lighting, nutrient delivery, and electric field control system as described for example below.

As illustrated in FIG. 1, system 300 may include a structural system 305, a growth system 310, and a control system 315. Growth system 310 and control system 315 may be movably attached to structural system 305.

As illustrated in FIGS. 1 and 2, structural system 305 may include a plurality of structural members 320, 325, and 330. Structural members 320, 325, and 330 may be any suitable type of structural member such as metal (e.g., aluminum, steel, or other suitable structural metal), plastic, composite, and/or any other suitable structural shape. Structural system 305 may include structural members 320, 325, and 330 arranged in any suitable configuration for supporting growth system 310 and control system 315. In at least some exemplary embodiments, structural members 320 and 325 may be horizontal members positioned perpendicularly to each other in a substantially horizontal plane and structural members 330 may be vertical members positioned substantially perpendicularly to structural members 320 and 325. Also for example, structural members 320, 325, and 330 may form structural system 305 that may be a lattice structure. Structural members 320, 325, and 330 may also be positioned at any desired angle or orientation relative to each other to form any suitable structural configuration for supporting growth system 310 and control system 315. Structural system 305 may also include components configured to operate with systems such as overhead transport systems and/or automated guided vehicles that may transport components of growth system 310 and/or control system 315. For example, structural system 305 may be a structure (e.g., a latticed structure) compatible with factory automation techniques to allow a variable positioning of components (e.g., pods) of growth system 310 and/or control system 315. Structural system 305 may also be a modular and/or scalable structural system, with a size and/or configuration of structural system 305 being variable based on addition, subtraction, and/or re-positioning of structural members 320, 325, and 330.

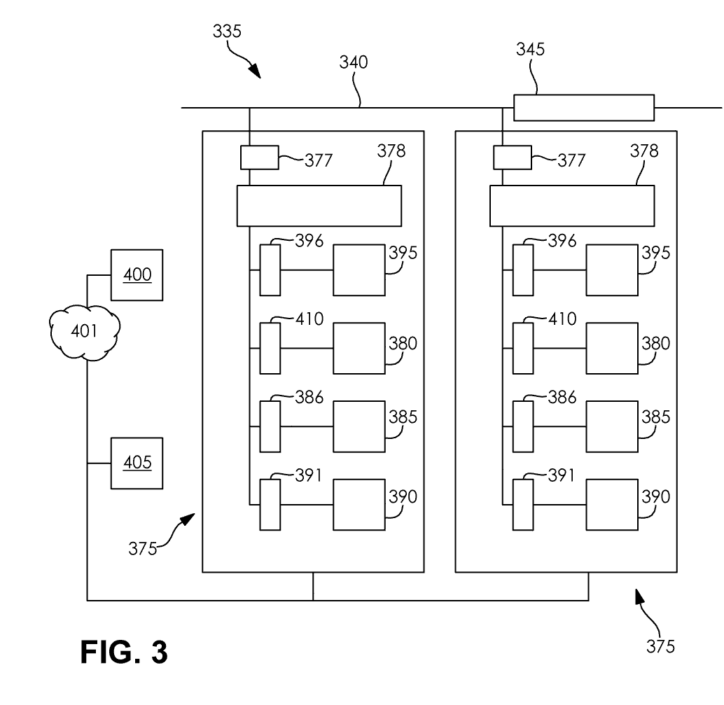

Structural system 305 may also include a power system 335. As illustrated in FIG. 3, power system 335 may include a power assembly 340 and a power converter 345. Power converter 345 may be for example a power transformer. For example, power converter 345 may transform power (e.g., such as electricity supplied by a remotely-located or co-located power supply source such as an AC power source) from a first voltage (e.g., between about 110 V and about 240 V or any other desired voltage) to a second voltage (e.g., 12 V). Power assembly 340 may be a power bus of any desired voltage (e.g., a 12 V power bus). Power assembly 340 may run through structural system 305. For example as illustrated in FIG. 1, power assembly 340 may be a power bus running within (e.g., partially or substantially completely within an interior of) and/or along structural members 320, 325, and/or 330. In at least some exemplary embodiments, power assembly 340 may be a 12 V power bus running through members 320, 325, and/or 330.

Structural system 305 may also include a plurality of connectors 350. Connector 350 may be for example a power connector. In at least some exemplary embodiments, connector 350 may be a magnetic connector that may be magnetically connected to a component of control system 315 (e.g., and/or growth system 310). In at least some exemplary embodiments, connector 350 may be a magnetic self-mating connector that may be configured (e.g., may have a protrusion and/or recess) to receive or be received by a component of control system 315 having a corresponding portion (e.g., a corresponding protrusion and/or recess). Connector 350 may also be a mechanical connector such as a mechanical power connector (e.g., an electrical plug or any other suitable connector). For example, connectors 350 may be regularly spaced (e.g., or variably spaced) along structural members 320, 325, and/or 330. Connectors 350 may be provided on any suitable portion of structural system 305 at any desired spacing. Connectors 350 may provide a relatively low voltage (e.g., 12 V) to control system 315 (e.g., or growth system 310).

As illustrated in FIGS. 1 and 2, growth system 310 may include a plurality of assemblies 352. Assembly 352 may include a housing 355, a growth member 360, and growth material 365. Housing 355 may support growth member 360, which may include growth material 365.

Housing 355 may be any suitable structural assembly for supporting growth member 360. Housing 355 (e.g., as well as any suitable components of structural system 305 and/or control system 315) may be formed from any suitable materials such as, for example, polymer material, structural metal (e.g., structural steel), co-polymer material, thermoplastic and thermosetting polymers, resin-containing material, polyethylene, polystyrene, polypropylene, epoxy resins, phenolic resins, Acrylanitrile Butadiene Styrene (ABS), Polycarbonate (PC), Mix of ABS and PC, Acetal (POM), Acetate, Acrylic (PMMA), Liquid Crystal Polymer (LCP), Mylar, Polyamid-Nylon, Polyamid-Nylon 6, Polyamid-Nylon 11, Polybutylene Terephthalate (PBT), Polycarbonate (PC), Polyetherimide (PEI), Polyethylene (PE), Low Density PE (LDPE), High Density PE (HDPE), Ultra High Molecular Weight PE (UHMW PE), Polyethylene Terephthalate (PET), PolPolypropylene (PP), Polyphthalamide (PPA), Polyphenylenesulfide (PPS), Polystyrene (PS), High Impact Polystyrene (HIPS), Polysulfone (PSU), Polyurethane (PU), Polyvinyl Chloride (PVC), Chlorinated Polyvinyl chloride (CPVC), Polyvinylidenefluoride (PVDF), Styrene Acrylonitrile (SAN), Teflon TFE, Thermoplastic Elastomer (TPE), Thermoplastic Polyurethane (TPU), and/or Engineered Thermoplastic Polyurethane (ETPU), or any suitable combination thereof. Side walls and a bottom wall of housing 355 may form a cavity 358 that may hold other components of growth system 310 and/or control system 315.

Housing 355 may be configured to be received and/or supported by structural system 305. For example, housing 355 may include recesses, apertures, and/or protrusion configured to be received by corresponding portions of structural system 305. Housing 355 may include one or more actuation assemblies 370. Actuation assembly 370 may operate to move assembly 352 along structural members 320, 325, and 330. Actuation assembly 370 may be any suitable type of actuation assembly for moving assembly 352 along structural system 305 and may include components such as, for example, an electro-mechanical actuator, hydraulic actuator, pneumatic actuator, and/or any other suitable devices for moving housing 355. Actuation assembly 370 may be a part of an automated transport system for moving and guiding assembly 352 along structural system 305. In at least some exemplary embodiments, growth system 310 may include a plurality of assemblies 352 that may be automated guided vehicles that may be moved on structural system 305.

Growth member 360 may be supported by side walls (e.g., or a bottom wall) of housing 355. Growth member 360 may form a top portion (e.g., upper boundary) of cavity 358. For example, growth member 360 may cover or seal cavity 358 of housing 355. Growth member 360 may be any suitable growing medium for the growth of plants or other organic material. Growth member 360 may include pre-sown grow mats that be formed from solid growing medium such as hemp, cellulose, bamboo fiber, micro fleece, and/or any other suitable mineral substrate. In at least some exemplary embodiments, growth member 360 may be treated by any suitable technique to provide for holding growth material 365 in a uniformly distributed manner during transportation and/or retaining a desired amount of moisture during germination phase of growth material 365. In at least some exemplary embodiments, growth member 360 may include polylactic acid (PLA) sheets. For example, growth member 360 may include one or more pre-seeded mats and one or more cold-water-dissolvable PLA sheets that may be thermally-sealed to protect the one or more pre-seeded mats. The one or more PLA sheets may be dissolved when for example soaked in water or exposed to moisture prior to or when growth member 360 is disposed in housing 355. Growth member 360 may include nanofibers to promote or aid in the germination process and/or provide anti-microbial capabilities. For example, growth member 360 may include seed mats that may be covered with nanofibers (e.g., potentially functionalized nanofibers). The exemplary nanofibers of growth member 360 may also provide for controlled (e.g., relatively slow) release of nutrients for suitable assimilation by growth material 365 (e.g., plants).

Growth material 365 may be disposed on growth member 360. Growth material 365 may be any suitable material for use in indoor growth and/or vertical farming such as, for example, seeds, plants, fungi, algae, and/or any other suitable organic material that may grow. For example, growth material 365 may be any suitable material that may be grown through farming techniques into nutrition-providing material for human beings, animals, or other organisms. In at least some exemplary embodiments, growth material 365 may be seed or plants for growing farming crops.

One or more assemblies 352 (e.g., including housing 355, growth member 360, and growth material 365) may be growth pods that may be of a predetermined size in order to be moved through an automated line using factory automation techniques such as overhead transport systems and/or automated guided vehicles. In addition to providing physical support for growth material 365, housing 355 (e.g., walls of housing 355) and/or growth member 360 may provide for desired germination in a relatively dark environment, block parasitic light from reaching neighboring plants (e.g., in neighboring assemblies 352), and/or screen out potentially harmful rays such as ultraviolet (UV) light from humans.

As illustrated in FIGS. 1-3, control system 315 may include one or more (e.g., a plurality) of node assemblies 375. Node assembly 375 may include a power converter 377, a controller 378, a lighting array 380, a dispensing array 385, a stimulator array 390, and a sensor array 395. In at least some exemplary embodiments, a single node assembly 375 of control system 315 may be co-located with each assembly 352 of growth system 310. In at least some exemplary embodiments, one or more node assemblies 375 of control system 315 may be co-located with one or more assemblies 352 of growth system 310.

As illustrated in FIG. 3, a plurality of node assemblies 375 may be powered via power assembly 340. Power converter 377, controller 378, lighting array 380, dispensing array 385, stimulator array 390, and/or sensor array 395 may be arranged in any suitable configuration (e.g., serial and/or parallel circuit) and powered via power assembly 340. Power converter 377 may be generally similar to power converter 345 and may convert power from a first voltage of power converter 377 (e.g., 12 V or any other desired voltage) to a second voltage (e.g., between about 110 V and about 240 V or any other desired voltage) that may power controller 378.

Controller 378 may control an operation of lighting array 380, dispensing array 385, stimulator array 390, and sensor array 395. Controller 378 may include for example a micro-processing logic control device or board components. Also for example, controller 378 may include input/output arrangements that allow it to be connected (e.g., via wireless and/or electrical connection) to lighting array 380, dispensing array 385, stimulator array 390, and/or sensor array 395. Controller 378 may be a microcontroller that is disposed on a control board that also includes a communication module or integrated circuit (IC) and/or a power block (e.g., with or without voltage adaptation provided for example by power converter 377). Controller 378 may also be connected to one or more exemplary user interfaces 400 and/or a growth module 405 (e.g., via an exemplary network 401 that may be similar to network 201 described below and/or via direct communication).

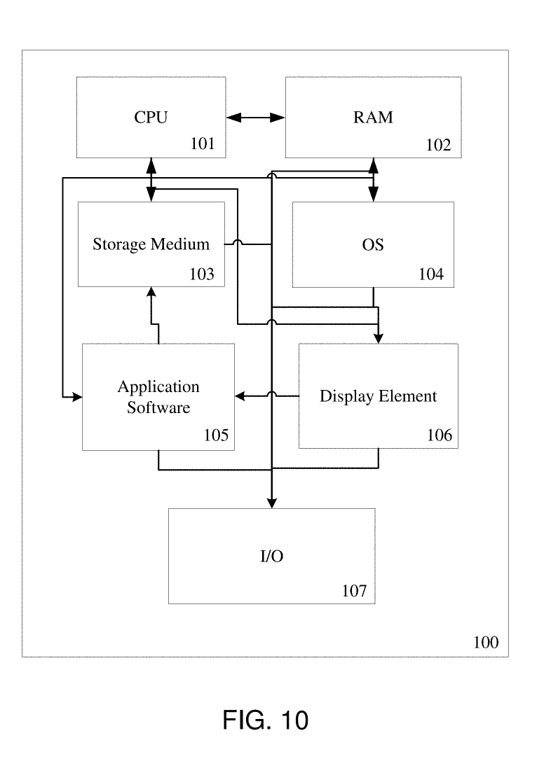

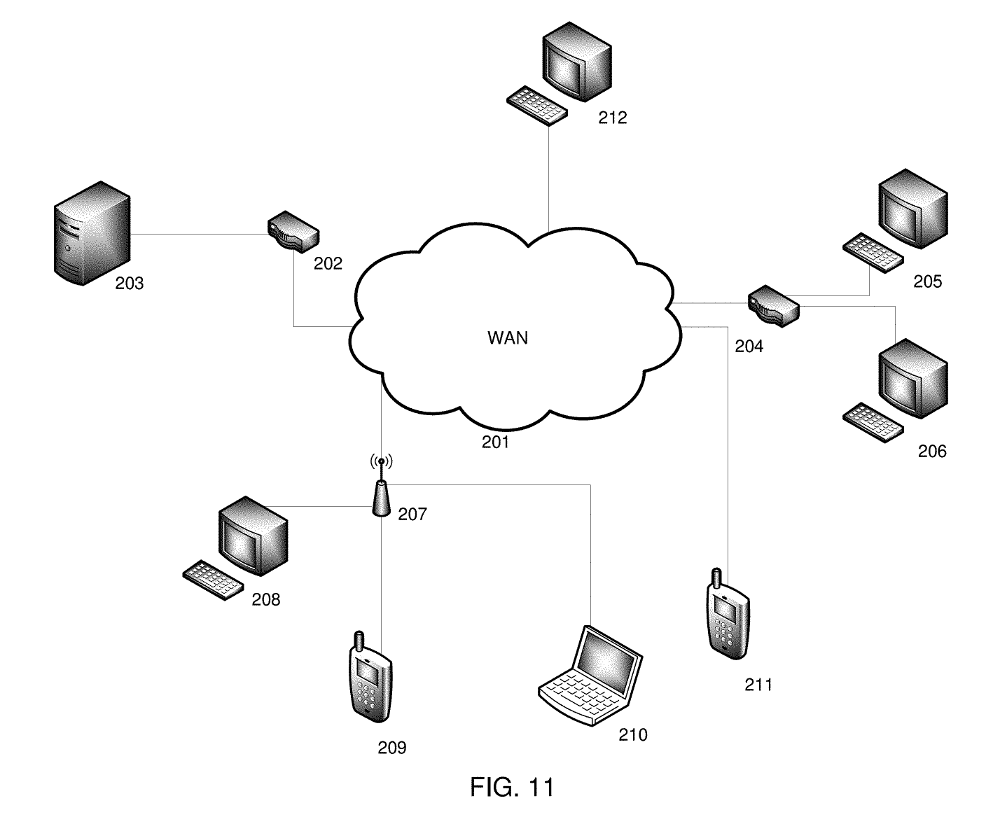

Growth module 405 may be partially or substantially entirely integrated with one or more components of system 300 such as, for example, network 401, user interface 400, and/or one or more node assemblies 375. Growth module 405 may include components similar to the exemplary components disclosed below regarding FIGS. 10 and 11. For example, growth module 405 may include computer-executable code stored in non-volatile memory. Growth module 405 may also include a processor, or alternatively, a processor for processing data associated with system 300 may be partially or substantially entirely integrated into any portion (e.g., or combination of portions) of system 300.

Growth module 405 and/or other suitable components of system 300 may utilize sophisticated machine learning and/or artificial intelligence techniques to perform predictive analysis using some or substantially all data collected by sensor arrays 395. For example, system 300 (e.g., growth module 405) may utilize the collected data to prepare and submit (e.g., via network 401, for example via wireless transmission such as via 4G LTE networks) datasets and variables to cloud computing clusters and/or other analytical tools (e.g., predictive analytical tools) which may analyze such data using artificial intelligence neural networks. Growth module 405 may for example include cloud computing clusters performing predictive analysis. For example, flow monitoring module 315 may utilize neural network-based artificial intelligence to predictively assess growth of growth material 365.

For example, exemplary artificial intelligence processes of growth module 405 may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. For example, exemplary artificial intelligence processes may also include processing for training a machine learning model to make predictions based on data collected by sensor arrays 395. For example, the prediction algorithms and approach may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets. Also for example, exemplary artificial intelligence processes may include processing for training a machine learning model to analyze, evaluate, and/or control an operation of system 300 (e.g., control node assemblies 375 via respective controllers 378) based on data collected by sensor arrays 395.

User interface 400 may be any suitable user interface for receiving input and/or providing output (e.g., raw data and/or results of predictive analysis described above such as recommendations) to a user. For example, user interface 400 may be a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface.

As illustrated in FIGS. 1, 3, and 4, lighting array 380 may include a power converter 410 and a plurality of lighting assemblies (e.g., a lighting assembly 415, a lighting assembly 420, a lighting assembly 425, and a lighting assembly 430). Lighting array 380 may for example include any desired number of lighting assemblies. Power converter 410 may be generally similar to power converter 345 and may convert power from a first voltage (e.g., of controller 378) to a second voltage (e.g., between about 3.3 V and about 5 V or any other desired voltage) that may power controller 378. A power connection 435 (e.g., a power bus or line carrying any desired voltage such as low voltage DC power, e.g., between about 3.3 V and about 5 V) may transfer power to lighting assembly 415, lighting assembly 420, lighting assembly 425, and lighting assembly 430. A connection 440 may be for example an input/output (I/O) (e.g., a TCP IP) connection that may also connect lighting assembly 415, lighting assembly 420, lighting assembly 425, and lighting assembly 430. In at least some exemplary embodiments, connection 440 may include a plurality of lines (e.g., a control over TCP IP line and a signal I/O line). For example, commands or predetermined files may be delivered via connection 440 (e.g., a TCP IP connection), and may be dispatched through percolation via a mesh network. In addition to lighting array 380, commands may be similarly sent on similar connections included in dispensing array 385, stimulator array 390, and/or sensor array 395. Lighting array 380 may also include a ground 445 (e.g., an electrical ground).

Lighting assembly 415, lighting assembly 420, lighting assembly 425, and lighting assembly 430 may be any suitable lighting assemblies for providing light to facilitate growth of growth material 365. For example, lighting assembly 415, lighting assembly 420, lighting assembly 425, and lighting assembly 430 may include light-emitting diodes (LEDs). Each of lighting assembly 415, lighting assembly 420, lighting assembly 425, and lighting assembly 430 may include an LED matrix. The exemplary LED matrix configuration may vary between the exemplary lighting assemblies. For example, lighting assembly 415 may have a first LED matrix configuration (e.g., m×n of any desired number of LEDs), lighting assembly 420 may have a second LED matrix configuration (e.g., j×k of any desired number of LEDs), lighting assembly 425 may have a third LED matrix configuration (e.g., o×p of any desired number of LEDs), and lighting assembly 430 may have a fourth LED matrix configuration (e.g., r×s of any desired number of LEDs). The various exemplary LED matrices may be similar or variable from each other. The exemplary LED matrices may include individually-controlled LEDs (e.g., LEDs that are individually controllable by controller 378).

In at least some exemplary embodiments, lighting assembly 415, lighting assembly 420, lighting assembly 425, and lighting assembly 430 may be any suitable type of LED (e.g., solid state LED) such as 5050 type devices. The exemplary LED matrices described above may be soldered to printed circuit boards that also include power connection 435, connection 440, and/or ground 445 as described for example herein. For example, the exemplary boards may include four lines (e.g., signal, control, ground and power). Controller 378 may individually control each LED of the exemplary matrices of lighting assembly 415, lighting assembly 420, lighting assembly 425, and lighting assembly 430, including individually (e.g., independently) adjusting an intensity of each RGB component of each LED.

In at least some exemplary embodiments, as a number of node assemblies 375 of control system 315 increases (e.g., as a size of structural system 305 increases), the exemplary LED matrices (e.g., any desired number of exemplary lighting assemblies) may be disposed in series and controlled via a single controller 378. For example, any suitable number of exemplary lighting assemblies may be disposed in series (e.g., or any other desired configuration) and controlled by any suitable technique. Lighting assemblies 415, 420, 425, and 430 (e.g., as well as any other component of node assembly 375) may be attached to structural system 305 by any suitable technique (e.g., via connectors 350). In at least some exemplary embodiments, lighting assemblies 415, 420, 425, and 430 may include plastic lenses and/or diffusing layers that may be disposed in front of the LEDs to adjust the emitted light as desired.

In at least some exemplary embodiments, the exemplary LEDs of lighting assemblies 415, 420, 425, and 430 may be pulsed to reduce power consumption and/or provide additional tuning of properties of growth material 365 (e.g., plants properties or properties of fungi or algae). The exemplary LEDs of lighting assemblies 415, 420, 425, and 430 may be controlled (e.g., based on an operation of growth module 405 and/or one or more controllers 378) to emit at desired (e.g., narrower or variable) wavelengths and spectrum bandwidths. Control system 315 and/or growth system 310 may include shield components or sleeve components (e.g., such as components described herein) that may shield users of system 300 from emissions of the exemplary LEDs. The LEDs may also be complemented with narrower spectrum sources (e.g., node assembly 375 may include additional lighting sources) to provide illumination in a desired range such as a red range (e.g., far red range such as between about 710 nm and about 850 nm) or a UV range (e.g., UV A, UV B, UV C, and/or a combination thereof). The exemplary LEDs of lighting assemblies 415, 420, 425, and 430 may be controlled to have a tunable spectrum ranging from UV to far red. The exemplary LEDs of lighting assemblies 415, 420, 425, and 430 may be controlled to have a target ratio of different wavelengths based on any desired criteria (e.g., as a function of a type or cultivar of growth material 365). In at least some exemplary embodiments, the exemplary LEDs of lighting assemblies 415, 420, 425, and 430 may be controlled to emit pure red light or pure blue light.

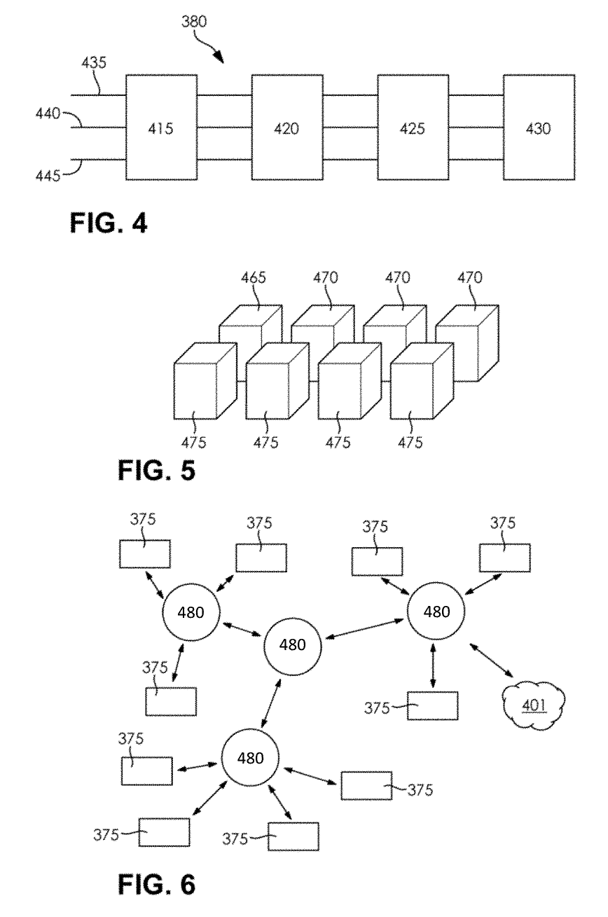

Lighting assembly 415, lighting assembly 420, lighting assembly 425, and lighting assembly 430 may be arranged in any desired configuration relative to each other and structural system 305. For example, lighting assemblies 415, 420, 425, and 430 (e.g., or any other desired number of exemplary lighting assemblies) may be disposed in a serial configuration as illustrated in FIG. 4. Each of lighting assemblies 415, 420, 425, and 430 may be disposed above growth material 365 as main lighting or top lighting. For example as illustrated in FIG. 1, lighting assembly 415 may be disposed above a canopy of growth material 365 as main lighting or top lighting. Each of lighting assemblies 415, 420, 425, and 430 may also be disposed to a side of growth material 365 or within a canopy of growth material 365 as intra-canopy or side lighting (e.g., satellite lighting). For example as illustrated in FIG. 4, lighting assemblies 420, 425, and 430 may be disposed to a side and/or within a canopy of growth material 365 as intra-canopy (e.g., disposed between a root portion and a canopy portion of growth material 365 when for example growth material 365 is a plant) or side lighting. Any of the exemplary lighting assemblies may serve as a termination lighting unit. For example as illustrated in FIG. 4, lighting assembly 430 may be a termination lighting unit. In at least some exemplary embodiments and as illustrated for example in FIG. 4, lighting assembly 415 may be a main lighting unit, lighting assemblies 420 and 425 may be satellite lighting units, and lighting assembly 430 may be a termination lighting unit.

As illustrated in FIGS. 1 and 3, dispensing array 385 may include one or more dispensing assemblies 450. Dispensing assemblies 450 may be removably attachable to structural system 305 and/or growth system 310. In at least some exemplary embodiments, dispensing assemblies 450 may be partially or substantially entirely integrated into respective housings 355. Dispensing array 385 may be powered via power converted by a power converter 386 that may be similar to the exemplary power converters described above. Dispensing array 385 may dispense material to growth material 365 using soil growth, soilless growth, and/or any other suitable growing technique. One or more dispensing assemblies 450 may include any suitable pumping device that may be coupled with other suitable powered accessories for dispensing a fluid (e.g., a liquid fluid, gaseous fluid, and/or any other suitable type of fluid) having nutrients to promote growth of growth material 365. Based on a type of growth material 365, dispensing assembly 450 may dispense liquid fluid and/or gaseous fluid that may be suitable for a given type of growth material 365. For example, dispensing assembly 450 may dispense liquid fluid and/or gaseous fluid such as drops, fog, mist, and/or any other suitable form or state. For example, dispensing assembly 450 may be an aeroponic dispenser or a hydroponic dispenser. For example, dispensing assembly 450 may deliver fluid via fluid flow (e.g., may be a fluid dispenser) or aerosol (e.g., may be an aerosol dispenser). For example, dispensing assembly 450 may be any suitable type of aerosol mister. In at least some exemplary embodiments, dispensing assembly 450 may be a piezoelectric fogger for aeroponics applications for growing growth material 365. Dispensing assembly 450 may also include any suitable components for reducing a probability of bacterial contamination of growth material 365 and/or other portions of system 300. For example, dispensing assembly 450 may contain UV C LEDs and/or any other suitable components for efficiently mitigating bacteria that may be encountered during growth of growth material 365. In at least some exemplary embodiments, dispensing assembly 450 may dispense fluid such as plasma activated water or water enriched with a source of nitrogen (e.g. from urea). For example, a UV treatment and/or plasma activation treatment may be used with fluids dispensed via dispensing array 385 (e.g., to reduce a probability of bacterial contamination).

As illustrated in FIGS. 1 and 3, stimulator array 390 may include one or more stimulator assemblies 455. Stimulator array 390 may be powered via power converted by a power converter 391 that may be similar to the exemplary power converters described above. Stimulator assembly 455 may be any suitable assembly for providing a stimulation (e.g., electrical current) to growth system 310 (e.g., to growth member 360). For example, stimulator assembly 455 may provide bioactive electrostimulation. Stimulator assembly may for example be disposed on housing 355 and/or any other suitable portion of growth system 310 and/or structural system 305. In at least some exemplary embodiments, stimulator assembly 455 may be an electrical device that provides electrical current (e.g., direct current) to growth member 360 so that direct current flows through growth member 360. In at least some exemplary embodiments, stimulator assembly 455 may provide electrical current to growth member 360 when growth material 365 may be a plant species such as lettuce, peppers, garden cress, or similar plant species. Stimulator assembly 455 may provide electrical current to growth member 360 at any desired stage of growth (e.g., based on an operation of growth module 405, controllers 378, and/or user input) or may be turned off completely based on any desired criteria (e.g., based on a type of growth member 360, type of growth material 365, and/or type of dispensing assembly 450 being utilized by system 300).

As illustrated in FIGS. 1 and 3, sensor array 395 may include one or more sensor assemblies 460. Sensor array 395 may be powered via power converted by a power converter 396 that may be similar to the exemplary power converters described above. Each sensor assembly 460 may be any suitable sensor for sensing characteristics that may indicate a rate of growth and/or a state (e.g., healthy state) of growth material 365 such as, for example, a visual sensor, a size sensor (e.g., a sensor that senses data of a size of growth material 365 for example by emitting electro-magnetic or other waves or infrared beams), a thermal sensor, a humidity sensor, a barometer, a hygrometer, a thermometer, a wet bulb device, an air quality sensor (e.g., sensor that senses particles disposed in ambient air), or any other suitable sensor. In at least some exemplary embodiments, sensor assembly 460 may be an ultrasonic range sensor or other suitable sensor that may determine a height of growth material 365 (e.g., a plant height). Sensor assembly 460 may be a near-infrared spectroscopy (NIRS) sensor or other suitable sensor for determining (e.g., for rapid evaluation of) growth, stress, and/or nutrition of growth material 365. For example, sensor assembly 460 may be a NIRS or ultrasonic distance measurement sensor for real time or near real time evaluation of growth rate and/or plant status. One or more sensor assemblies 460 of sensor array 395 may be added to each node assembly 375 to provide closed loop feedback. The data sensed by sensor array 395 may be provided to respective controller 378 and/or growth module 405. The sensed data may be used by system 300 (e.g., controller 378 and/or growth module 405) to determine deviations from desired properties of growth material 365 (e.g., the growing living species), and used in a feedback loop to control adjustments of node assemblies 375 of control system 315.

As illustrated in FIG. 3, components of node assembly 375 may be electrically connected and powered via power assembly 340 (e.g., node assembly 375 may be connected to power assembly 340 via connector 350). Components of node assembly 375 may also communicate via wireless, wire communication, and/or any other suitable communication technique. Some or all components of node assembly 375 may be co-located and/or integrated with each other or disposed remotely from each other (e.g., at different desired locations of a given growth system 310). Node assemblies 375 may be controlled via respective controllers 378, growth module 405, and/or input provided by a user via user interface 400. In at least some exemplary embodiments, a given node assembly 375 may be partially or substantially entirely integrated into a given assembly 352, with the given node assembly 375 being connected to one or more connectors 350 disposed at a portion of structural system 305 at which the given assembly 352 is disposed. Components of node assembly 375 may have any suitable configuration for connection to structural system 305. For example, components of node assembly 375 may have some varying (e.g., unique) dimensions, while having other dimensions (e.g., a width dimension) that may be similar or identical to facilitate interchangeably attaching components of node assembly 375 to various locations on structural system 305.

System 300 may include any suitable ventilation or air circulation system for providing suitable air flow. For example, an exemplary ventilation system may be included in growth system 310 and/or control system 315. Any other desired systems may be included in system 300 such as, for example, security systems, fire control systems, surveillance systems, and/or any other suitable system for use in indoor growth (e.g., vertical farming).

As illustrated in FIG. 5, system 300 may include a plurality of growth zones, each including a plurality of assemblies 352, node assemblies 375, and exemplary structural members of structural system 305. Each of the exemplary growth zones may be in any suitable stage of growth (e.g., and different stages of growth may be occurring within a single growth zone). For example, growth zone 465 may be in an early growth zone having relatively high pod density as described for example below, growth zones 470 may be in an intermediate or mid-stage growth zone having medium or average pod density as described for example below, and growth zones 475 may be in a final growth zone having relatively low pod density as described for example below.

In at least some exemplary embodiments and as illustrated in FIG. 6, system 300 may utilize a TCP/IP (Transmission Control Protocol/Internet Protocol) or any other suitable wireless technology and communication protocol for communication. For example, system 300 may utilize a communication technique such as Bluetooth Mesh or Software Defined Radios. The exemplary mesh networking communication system of system 300 may provide communication over large distance and to facilitate addition or removal of exemplary nodes (e.g., node assemblies 375). The communication system may include a plurality of node assemblies 375 and a plurality of relay nodes 480. Some node assemblies 375 may have relatively extensive computing capabilities (e.g., powerful controllers 378) for running complex algorithms, artificial intelligence processes, communication, and/or control, while other node assemblies 375 may include relatively small microcontrollers (e.g., small controllers 378) to components such as control pumps of dispensing array 385, LEDs of lighting array 380, DC current of stimulator array 390 for electrostimulation, and/or any other desired components of node assemblies 375. In at least some exemplary embodiments, system 300 may include additional control nodes (e.g., with powerful computing capabilities) for controlling one or more node assemblies 375. Relay nodes 480 may facilitate communication between groups of node assemblies 375 and remote computing resources via network 401 (e.g., via any suitable gateway). Growth module 405 may be integrated into node assemblies 375 and/or network 405. In at least some exemplary embodiments, node assemblies 375 having relatively greater computing capacity compared to other node assemblies 375 may process data received and transmitted by sensor arrays 395 of a plurality of node assemblies 375 (e.g., nearby node assemblies 375) and may control an operation of those node assemblies 375 via their respective controllers 375 (e.g., to modify or adapt an illumination, dispensing of nutrients, and/or electro stimulation based on analyzing the sensed data of sensor arrays 395). In at least some exemplary embodiments, system 300 may include a mesh networking topology that interconnects a plurality of node assemblies 375 (e.g., control units), the topology providing short range wireless communication and/or remote control using network (e.g., internet) protocols.

In at least some exemplary embodiments, system 300 may utilize a “lights-out” manufacturing system or technique. Manufacturing automation may be provided through the use of standardized-sized assemblies 352 (e.g., pods) that may be transported between different operational areas (e.g., different exemplary growth zones as illustrated in FIG. 5) using factory wide transport systems. Assemblies 352 (e.g., carriers such as “wafer carriers”) may for example include components for environmental control to reduce contaminants on assemblies 352 or other portions of system 300.

In at least some exemplary embodiments, system 300 may be a system for indoor growth of growth material 365 (e.g., plants, fungi, or other exemplary material described herein) in an automated and reproducible manner. The exemplary growth may take place through any suitable structure (e.g., structural system 305 that may be a lattice structure), to which self-contained control nodes such as node assemblies 375 (e.g., including LED lighting, nutrient-dispensing devices, and DC current electro-stimulation control nodes) are attached. These units (e.g., node assemblies 375 and/or assemblies 352) may be interchangeably placed along structural system 305 (e.g., along vertices of a rigid structure) and may be repositioned to provide additional space as growth material 365 grows (e.g., as plants grow through the lattice). Exemplary LEDs disposed within the lighting units (e.g., lighting assemblies as described for example above) may be individually controlled and may provide growth material 365 (e.g., plants) with desired wavelengths ranging from UV to a far red spectrum for each growth stage (e.g., in a spatially uniform fashion). Tuning of the environmental parameters through the growth stages of growth material 365 (e.g., live organisms) may be determined via machine learning algorithms and sensors in order to attempt to maximize production for example in terms of growth rate, taste, morphology, and/or nutritional qualities.

The exemplary disclosed apparatus, system, and method may be used in any suitable application for indoor growing. For example, the exemplary disclosed apparatus, system, and method may be used in any suitable application for indoor environment growth such as a vertical farming system. The exemplary disclosed apparatus, system, and method may be used in any suitable application for providing growth of organic material in a controlled environment.

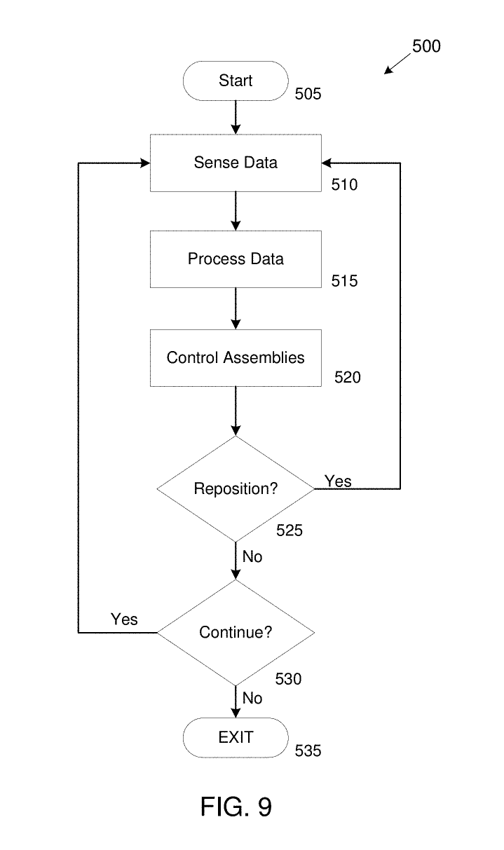

An exemplary operation of the exemplary disclosed apparatus, system, and method will now be described. For example, FIG. 9 illustrates an exemplary process 500. Process 500 starts at step 505. At step 510, sensor array 395 may operate to sense data associated with growth material 365. The exemplary sensors as described for example above may sense a height of growth material 365, parameters such as growth rate, stress, and nutrition of growth material 365, and/or any other desired characteristics (e.g., temperature, moisture content, ambient conditions). Sensor array 395 may sense data at predetermined regular or variable intervals, continuously, and/or when requested based on input provided to system 300 via user interface 400.

Sensed data may be transmitted from sensor array 395 to controller 378 (e.g., a given sensor array 395 of a given node assembly 375 may transmit data to a given controller 378 of that node assembly 375). Controller 378 may immediately process the sensed data as described below in real time or near real time.

At step 515, system 300 may process and analyze the data sensed and provided at step 510. System 300 may process the data using any suitable processing method such as for example the exemplary processing, analysis, and artificial intelligence techniques described herein. System 300 may process the sensed data using any suitable mesh networking techniques as described for example above. Controllers 378 of control system 315 may operate as a mesh network to process data in accordance with their respective computing power as described for example above. Growth module 405 as described for example above may also operate as part of the exemplary mesh network to process the sensed data. In at least some exemplary embodiments, sensed data and processed data may be transferred between controller 378 and growth module 405 as system 300 utilizes its aggregate computing power to perform analysis and artificial intelligence operations as a mesh network to process data during step 515.

In at least some exemplary embodiments during step 515, system 300 may analyze the sensed data to determine commands or lighting instructions (e.g., light recipes) for controlling LEDs of lighting arrays 380 as described further below. The exemplary lighting instructions may for example include CIE (e.g., CIE 1931) coordinates, light intensity values, and/or durations for individually controlling each LED during illumination of growth material 365. For example, growth module 405 may include predetermined data correlating sensed data that may indicate criteria such as essential oil content, taste, vitamin content, and/or protein content with photonic wavelength selection for LEDs. In at least some exemplary embodiments, growth module 405 may include such data for plant species such as Ocimum Basilicum and any other desired types of growth material 365. System 300 may thereby determine LED operation instructions (e.g., CIE coordinates, intensity, duration, and/or any other suitable criteria) based on analyzing the sensed data in view of the exemplary predetermined criteria (e.g., oil, content, taste, vitamin content, and/or protein content) described for example above.

In at least some exemplary embodiments during step 515, system 300 may determine instructions (e.g., growth recipes) for controlling lighting arrays 380, dispensing arrays 385, and/or stimulator arrays 390 based on analyzing sensed data in view of any suitable predetermined criteria. For example, such exemplary predetermined criteria may include information for increasing (e.g., attempting to maximize) growing production of growth material 365 based on characteristics related to suitable growth rate, taste, morphology, nutrition, and/or any other suitable predetermined data.

In at least some exemplary embodiments during step 515, system 300 may perform machine learning (e.g., using controllers 378 and/or growth module 405) to determine light delivery optimization according to any suitable criteria (e.g., plant variety or cultivar) in real time or quasi real time (e.g. during step 520). System 300 may also determine instructions for fuzzy logic control of a nutrients balance (e.g., based on controlling dispensing array 385) of growth material 365 in real time or quasi real time (e.g., during step 520).

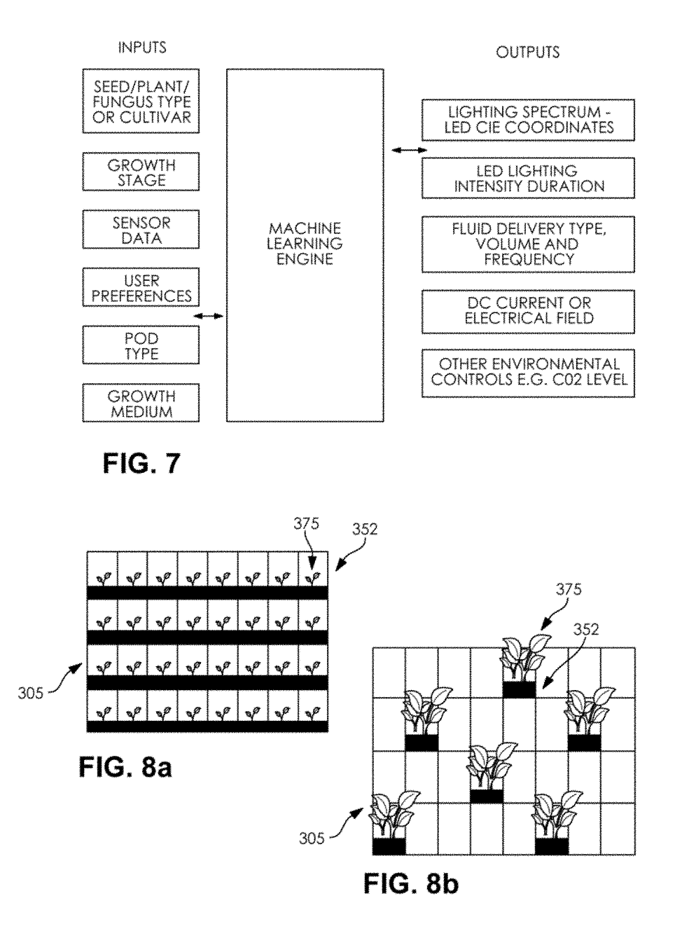

In at least some exemplary embodiments during step 515, system 300 may performing machine learning operations as illustrated in FIG. 7. Exemplary inputs may include a type or cultivar of growth material 365, a growth stage (e.g., as described for example relating to FIG. 5), data sensed at step 510, user preferences and/or any other desired user input provided for example via user interface 400, a type of assembly 352 (e.g., pod type), a type of growth member 360, and/or any other desired input information. Based on performing processing and/or artificial intelligence operations as described for example herein, system 300 may provide output information (e.g., via user interface 400). Exemplary output information may include instructions for controlling components of system 300 during step 520 and/or output provided to a user. Exemplary instructions (e.g., growth recipes) for controlling components of system 300 during step 520 may include CIE coordinates (e.g., lighting spectrum for illumination) for LEDs of lighting arrays 380, lighting intensity and/or duration for LEDs of lighting arrays 380, fluid criteria (e.g., type, volume, frequency, flow rate, and/or any other desired criteria) for liquid fluid and/or gaseous fluid to be provided by dispenser arrays 385, level of DC current or electrical field to be provided by stimulator arrays 390, ambient condition (e.g., environmental) controls of an area in which a given assembly 352 is disposed (e.g., carbon dioxide levels, temperature, humidity, and/or any other suitable condition), and/or any other suitable instructions (e.g., growth recipes) for controlling an operation of components of system 300.

Returning to FIG. 9, system 300 may proceed to step 520. At step 520, system 300 may control (e.g., via controllers 378 and/or growth module 405) lighting arrays 380, dispensing arrays 385, stimulator arrays 390, sensor arrays 395, and/or any other suitable component of system 300 based on processing (e.g., instructions or growth recipes that were determined based on processing), analysis, artificial intelligence operations, and/or any other exemplary activities performed during step 515. In at least some exemplary embodiments, system 300 may control operations of the exemplary components via an exemplary mesh network as described herein.

In a least some exemplary embodiments, instructions (e.g., growth recipes or “scenes”) that were determined at step 515 may be transferred to the exemplary components of system 300 (e.g., may be sent over the network, e.g., mesh network). In at least some exemplary embodiments, cloud-based and/or local upload of instructions or recipes (e.g., determined at step 515) for control of lighting arrays 380, dispensing arrays 385, stimulator arrays 390, sensor arrays 395, and/or any other suitable components of system 300 for growing growth material 365 may be provided via a wireless mesh network. For example, one or more controllers 378 and/or growth module 405 may individually control a single LED or control a group of LEDs of lighting arrays 380 based on command instructions containing CIE coordinates and/or recommended LED intensities (e.g., set on a scale from 0 to 255). As described for example herein, the LED instructions may be optimized based on processing at step 515 for a desired growth function of growth material 365 to be performed such as germination, growth, flowering, fruit ripening, and/or any other desired growth function. Instructions controlling an operation of dispensing arrays 385 (e.g., a desired flow rate, UV disinfection, and/or any other desired instruction) and/or for controlling an operation of stimulator arrays 390 (e.g., as well as sensor arrays 395) may be similarly transferred to control components of system 300. An overall growth protocol of growth material 365 may thereby be controlled by system 300.

In a least some exemplary embodiments, steps 510, 515, and 525 may be iteratively performed as a closed control loop capability. For example in addition to the exemplary mesh network described above, each node assembly 375 may operate in a closed control loop (e.g., a given controller 378 of a given node assembly 375 may control that node assembly 375 in a closed loop). Also for example, a controller 378 of a given node assembly 375 may control that node assembly 375 as well as other node assemblies 375 in a closed loop (e.g., when the given node assembly 375 has suitable computing power) or as part of an exemplary mesh network as described for example herein (e.g., as illustrated in FIG. 6).

Returning to FIG. 9, system 300 may proceed to step 525. At step 525, system 300 may determine whether or not one or more assemblies 352 and/or one or more node assemblies 375 are to be repositioned (e.g., based on the exemplary processes of step 515). One or more assemblies 352 and/or one or more node assemblies 375 may be repositioned manually by users of system 300 and/or via automation controlled by controllers 378 and/or growth module 405 using any suitable automation technique for example as described above.

In at least some exemplary embodiments, one or more node assemblies 375 may be detached from one or more connectors 350 at a first position of structural system 305, moved to a second position of structural system 305, and connected to one or more connectors 350 at the second position of structural system 305. In at least some exemplary embodiments, a given node assembly 375 integrated into a given assembly 352 may be disconnected from connectors 350 (e.g., magnetic connectors) at a first position of structural system 305, moved along with assembly 352 to a second position of structural system 305 (e.g., via automated or manual movement), and then connected to connectors 350 (e.g., magnetic connectors) at the second position.

FIGS. 8A and 8B illustrate an exemplary repositioning of a plurality of assemblies 352 and node assemblies 375. For example as growth material 365 (e.g., plants) grow, it may be suitable to adjust a spacing of assemblies 352 and node assemblies 375. As illustrated in FIGS. 8A and 8B, a spacing of assemblies 352 and node assemblies 375 on structural system 305 (e.g., a latticed structure) may be adjusted.

FIG. 8A illustrates an exemplary spacing that may correspond to an exemplary early growth stage (e.g., similar to growth zone 465) as described above relating to FIG. 5. As shown in FIG. 8A, assemblies 352 and node assemblies 375 may be relatively closely spaced on structural system 305. In FIG. 8A for example, lighting arrays 380 may provide main or top lighting (e.g., similar to lighting assembly 415 illustrated in FIG. 1). For example, FIG. 8A illustrates an exemplary high density pod spacing at a relatively early growth stage.

FIG. 8B illustrates an exemplary spacing that may correspond to an exemplary intermediate or final growth stage (e.g., similar to growth zones 470 or 475) as described above relating to FIG. 5. As shown in FIG. 8B, assemblies 352 and node assemblies 375 may be spaced away from each other (e.g., spaced increasingly away from each other) on structural system 305. In FIG. 8B for example, lighting arrays 380 may provide both main or top lighting (e.g., similar to lighting assembly 415 illustrated in FIG. 1) and intra-canopy lighting (e.g., similar to lighting assemblies 420, 425, and/or 430 illustrated in FIG. 1). For example, FIG. 8B illustrates an exemplary medium or low density pod spacing at an intermediate or final growth stage.

Returning to FIG. 9, system 300 may return to step 510 after a repositioning of some or all assemblies 352 and node assemblies 375 has been performed at step 525. If repositioning is not to be performed (e.g., based on processing at step 515, control at step 520, and/or user input), system 300 may proceed to step 530.

At step 530, system 300 may determine whether or not to continue process 500 (e.g., a growth of growth material 365) based on processing at step 515, predetermined criteria, and/or user input. If process 500 is to continue, system 300 returns to step 510 (e.g., growth of growth material 365 continues). If process 500 is to end (e.g., some or all growth material 365 is to be removed or harvested), system 300 may proceed to step 535, ending process 500.

In at least some exemplary embodiments, the exemplary disclosed method may include providing a first movable assembly (e.g., assembly 352) that is movable between a first location and a second location of a structure (e.g., structural system 305), providing a second movable assembly (e.g., assembly 352) that is movable between a third location and a fourth location of the structure, and disposing a first growth material (e.g., growth material 365) in the first movable assembly and a second growth material (e.g., growth material 365) in the second movable assembly. The exemplary disclosed method may also include illuminating the first growth material from a first position at the first location at a first time and from a second position at the second location at a second time, and illuminating the second growth material from a third position at the third location at the first time and from a fourth position at the fourth location at the second time. A first distance between the first location and the third location may be less than a second distance between the second location and the fourth location. The second position may be an intra-canopy position of the first growth material. The fourth position may be an intra-canopy position of the second growth material. The first growth material may be a first plant and the intra-canopy position of the first growth material may be disposed below a canopy of the first plant, and the second growth material may be a second plant and the intra-canopy position of the second growth material may be disposed below a canopy of the second plant. The exemplary disclosed method may further include sensing data of the first and second growth materials. The exemplary disclosed method may further include dispensing a fluid to the first and second growth materials based on the sensed data. The exemplary disclosed method may also include providing an electric current to a first medium on which the first growth material is disposed and to a second medium on which the second growth material is disposed based on the sensed data. The first movable assembly may be moved between the first location and the second location based on the sensed data and the second movable assembly may be moved between the third location and the fourth location based on the sensed data. The first and second growth materials may each be in an early growth stage at the first time and are each in a final growth stage at the second time. The first and second movable assemblies may be in a high density arrangement at the first time and may be in a low density arrangement at the second time, the first and second movable assemblies being disposed further away from each other in the low density arrangement as compared to the high density pod arrangement. A magnetic connector may be disposed at each of the first position, second position, third position, and fourth position. Illuminating the first growth material from the first position, illuminating the first growth material from the second position, illuminating the second growth material from the third position, and illuminating the second growth material from the fourth position may each include individually controlling each of a plurality of LEDs, based on the sensed data, to vary an operation selected from the group consisting of varying a set of CIE coordinates, varying an illumination intensity, and varying an illumination duration. The structural system may be a lattice structure and the first and second growth material may each be selected from the group consisting of plants, fungi, and algae.

In at least some exemplary embodiments, the exemplary disclosed system may include a growth module (e.g., growth module 405), comprising computer-executable code stored in non-volatile memory, a processor, a sensor array (e.g., a sensor array 395), a lighting array (e.g., a lighting array 380), and a dispensing array (e.g., a dispensing array 385). The growth module, the processor, the sensor array, the lighting array, and the dispensing array may be configured to sense data of a growth material (e.g., growth material 365) using the sensor array, process the sensed data, illuminate the growth material using the lighting array, dispense a fluid to the growth material using the dispensing array, vary a position of at least one lighting assembly of the lighting array between a first position and a second position based on the sensed data, vary an illumination intensity and an illumination duration of the lighting array based on the sensed data, and vary an amount of the dispensed fluid based on the sensed data. The first position may be disposed above a canopy of the growth material and the second position may be disposed below the canopy of the growth material. The growth module, the processor, the sensor array, the lighting array, and the dispensing array may be configured to vary a set of CIE coordinates at which the at least one lighting assembly illuminates the growth material. The at least one lighting assembly may illuminate the growth material from the second position using either pure red light or pure blue light based on the sensed data. The at least one lighting assembly may illuminate the growth material from the second position using a far red range of between 710 nm and 850 nm based on the sensed data. UV treatment or plasma activation may be applied to the fluid based on the sensed data.

In at least some exemplary embodiments, the exemplary disclosed method may include disposing one or more plants in each of a plurality of movable assemblies (e.g., assemblies 352), sensing data of each of the one or more plants, and disposing each of the plurality of movable assemblies on a lattice structure, the plurality of movable assemblies movable from a high density arrangement on the lattice structure at a first time to a low density arrangement on the lattice structure at a second time based on the sensed data. The exemplary disclosed method may also include illuminating each of the one or more plants using a movable lighting array (e.g., lighting array 380) for each of the plurality of movable assemblies. For each of the plurality of movable assemblies disposed in the high density arrangement at the first time, the movable lighting array may illuminate the one or more plants from above a canopy of the one or more plants based on the sensed data. For each of the plurality of movable assemblies disposed in the low density arrangement at the second time, the movable lighting array may illuminate the one or more plants from both above a canopy of the one or more plants and below the canopy of the one or more plants based on the sensed data. The plurality of movable assemblies may be spaced further apart from each other in the low density arrangement as compared to the high density arrangement. For each of the plurality of movable assemblies, the movable lighting array may include a first lighting assembly disposed above the canopy of the one or more plants at the first and second times, and a second lighting assembly movable from a first position above the canopy of the one or more plants at the first time to a second position below the canopy of the one or more plants at the second time based on the sensed data. The second lighting assembly may illuminate the one or more plants from the second position using either pure red light or pure blue light based on the sensed data.

The exemplary disclosed apparatus, system, and method may provide techniques for adjusting lighting, nutrient delivery, and electric field control to provide for suitable (e.g., optimized) indoor growth conditions. For example, the exemplary disclosed apparatus, system, and method may provide suitable intra-canopy lighting to plants. The exemplary disclosed apparatus, system, and method may also improve energy efficiency and optimize lighting for plant or fungi growth in controlled environments. Also for example, the exemplary disclosed apparatus, system, and method may provide for efficient control of desired variable lighting attributes that may be suitable for indoor growth of plants.

An illustrative representation of a computing device appropriate for use with embodiments of the system of the present disclosure is shown in FIG. 10. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 11, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 11, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed apparatus, system, and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A method, comprising:
providing a first movable assembly that is movable between a first location and a second location of a structure;
providing a second movable assembly that is movable between a third location and a fourth location of the structure;
disposing a first growth material in the first movable assembly and a second growth material in the second movable assembly;
illuminating the first growth material from a first position at the first location at a first time and from a second position at the second location at a second time; and
illuminating the second growth material from a third position at the third location at the first time and from a fourth position at the fourth location at the second time;
wherein a first distance between the first location and the third location is less than a second distance between the second location and the fourth location;
wherein the second position is an intra-canopy position of the first growth material; and
wherein the fourth position is an intra-canopy position of the second growth material.

2. The method of claim 1, wherein:
the first growth material is a first plant and the intra-canopy position of the first growth material is disposed below a canopy of the first plant; and
the second growth material is a second plant and the intra-canopy position of the second growth material is disposed below a canopy of the second plant.

3. The method of claim 1, further comprising sensing data of the first and second growth materials.

4. The method of claim 3, further comprising dispensing a fluid to the first and second growth materials based on the sensed data.

5. The method of claim 3, further comprising providing an electric current to a first medium on which the first growth material is disposed and to a second medium on which the second growth material is disposed based on the sensed data.

6. The method of claim 3, wherein the first movable assembly is moved between the first location and the second location based on the sensed data and the second movable assembly is moved between the third location and the fourth location based on the sensed data.

7. The method of claim 1, wherein the first and second growth materials are each in an early growth stage at the first time and are each in a final growth stage at the second time.

8. The method of claim 1, wherein the first and second movable assemblies are in a high density arrangement at the first time and are in a low density arrangement at the second time, the first and second movable assemblies being disposed further away from each other in the low density arrangement as compared to the high density pod arrangement.

9. The method of claim 1, wherein a magnetic connector is disposed at each of the first position, the second position, the third position, and the fourth position.

10. The method of claim 3, wherein illuminating the first growth material from the first position, illuminating the first growth material from the second position, illuminating the second growth material from the third position, and illuminating the second growth material from the fourth position each include individually controlling each of a plurality of LEDs, based on the sensed data, to vary an operation selected from the group consisting of varying a set of CIE coordinates, varying an illumination intensity, and varying an illumination duration.

11. The method of claim 1, wherein the structural system is a lattice structure and the first and second growth material are each selected from the group consisting of plants, fungi, and algae.

12. A system, comprising:
a growth module, comprising computer-executable code stored in non-volatile memory;
a processor;
a sensor array;
a lighting array; and
a dispensing array
wherein the growth module, the processor, the sensor array, the lighting array, and the dispensing array are configured to:
sense data of a growth material using the sensor array;
process the sensed data;
illuminate the growth material using the lighting array;
dispense a fluid to the growth material using the dispensing array;
vary a position of at least one lighting assembly of the lighting array between a first position and a second position based on the sensed data;
vary an illumination intensity and an illumination duration of the lighting array based on the sensed data; and
vary an amount of the dispensed fluid based on the sensed data;
wherein the first position is disposed above a canopy of the growth material and the second position is disposed below the canopy of the growth material.

13. The system of claim 12, wherein the growth module, the processor, the sensor array, the lighting array, and the dispensing array are configured to vary a set of CIE coordinates at which the at least one lighting assembly illuminates the growth material.

14. The system of claim 12, wherein the at least one lighting assembly illuminates the growth material from the second position using either pure red light or pure blue light based on the sensed data.

15. The system of claim 12, wherein the at least one lighting assembly illuminates the growth material from the second position using a far red range of between 710 nm and 850 nm based on the sensed data.

16. The system of claim 12, wherein UV treatment or plasma activation is applied to the fluid based on the sensed data.

17. A method, comprising:
disposing one or more plants in each of a plurality of movable assemblies;
sensing data of each of the one or more plants;
disposing each of the plurality of movable assemblies on a lattice structure, the plurality of movable assemblies movable from a high density arrangement on the lattice structure at a first time to a low density arrangement on the lattice structure at a second time based on the sensed data; and
illuminating each of the one or more plants using a movable lighting array for each of the plurality of movable assemblies;
wherein for each of the plurality of movable assemblies disposed in the high density arrangement at the first time, the movable lighting array illuminates the one or more plants from above a canopy of the one or more plants based on the sensed data; and
wherein for each of the plurality of movable assemblies disposed in the low density arrangement at the second time, the movable lighting array illuminates the one or more plants from both above a canopy of the one or more plants and below the canopy of the one or more plants based on the sensed data.

18. The method of claim 17, wherein the plurality of movable assemblies are spaced further apart from each other in the low density arrangement as compared to the high density arrangement.

19. The method of claim 18, wherein for each of the plurality of movable assemblies, the movable lighting array includes a first lighting assembly disposed above the canopy of the one or more plants at the first and second times, and a second lighting assembly movable from a first position above the canopy of the one or more plants at the first time to a second position below the canopy of the one or more plants at the second time based on the sensed data.

20. The method of claim 19, wherein the second lighting assembly illuminates the one or more plants from the second position using either pure red light or pure blue light based on the sensed data.
